(19) United States
(12) Patent Application Publication
(10) Pub. No.: US 2015/0111803 A1
(43) Pub. Date: Apr. 23, 2015

(54) CLEANING COMPOSITIONS

(71) Applicant: 3M INNOVATIVE PROPERTIES COMPANY, St. Paul, MN (US)

(72) Inventors: Zhilan Liu, Shanghai (CN); Ting Liu, Shanghai (CN); Ying Wei Xie, Shanghai (CN); Kai Qiu, Shanghai (CN)

(21) Appl. No.: 14/402,440

(22) PCT Filed: May 24, 2012
(86) PCT No.: PCT/CN2012/075983

§ 371 Date: Nov. 20, 2014

(51) Int. Cl. C11D 1/722; C11D 3/34; C11D 3/22

(52) U.S. Cl. CPC C11D 1/722; C11D 3/221; C11D 3/3418
USPC 510/161

(57) ABSTRACT

A cleaning composition comprises A) a fatty alcohol-alkylene oxide copolymer, B) a glycoside, and C) a benzene sulfonate, wherein, the weight ratio of the component B and the component C is less than or equal to 5:1. The cleaning composition can be used as a detergent for cleaning medical appliances.

### TECHNICAL FIELD

The present invention generally relates to the field of medical appliance cleaning, and specifically, relates to a cleaning composition for cleaning medical appliances.

### BACKGROUND OF THE INVENTION

Medical appliance cleaning is very important for infection control in hospital. There are many different kinds of detergents for cleaning medical appliances, such as enzyme-containing detergents, alkaline detergents, acid detergents, or the like (see, U.S. Pat. No. 6,562,296; US20090061017; and WO8809369).

In hospitals, the medical appliances are cleaned in an automatic manner or a manual manner. For the automatic cleaning, jet washing has become a popular method, which utilizes water pressure to remove soils from the objects to be washed. Conventional surfactants have issues when used in this washing method with a high foaming power. Much foam will weaken jet water pressure and lead to an unsatisfactory washing effect. More importantly, machine will give an alarm and can not operate favorably. This will affect cleaning efficiency, which is unaccepted for medical appliance cleaning in hospital for limited time. So a cleaning composition with a low foam level is preferred.

Additionally, with regard to manual washing, a transparent dilution is necessary. Usually, a cleaning detergent is a concentrate, and in order to obtain a high cleaning efficiency, a customer will dilute the cleaning detergent with warm water at a temperature of about 40-60° C. Currently, in order to achieve a low foam level, a detergent including a block copolymer type nonionic surfactant is mainly utilized (see, U.S. Pat. No. 6,530,383). The block copolymer type nonionic surfactant includes an ethylene oxide (EO) block, a propylene oxide (PO) block or the like. However, these kinds of surfactants generally have a low cloud point that is lower than 40° C., and when the dilution temperature is higher than 40° C., the solution will be clouding. Thus, it is very inconvenient for manual washing. Medical appliances will be unseen in the solution under the dilution, which may hurt the hands of the operator, and some fine accessories will be lost because they cannot be observed easily.

Therefore, at present, there is a great need to develop a cleaning composition with a high cloud point and a low foam level for cleaning medical appliances.

### SUMMARY OF THE INVENTION

The invention has been accomplished to attain the above object. Through intensive investigations, the present inventors have surprisingly found that a cleaning composition with a high cloud point and a low foam level for cleaning medical appliances can be obtained by mixing a specific alkoxylated surfactant (that is, a fatty alcohol-alkylene oxide copolymer), a specific glycoside and a specific benzene sulfonate in a specific ratio by weight among them. The combination of the glycoside and the benzene sulfonate can provide a synergistic effect on the clouding and foaming properties of the obtained cleaning composition.

Therefore, an object of the invention is to provide a cleaning composition comprising A) a fatty alcohol-alkylene oxide copolymer, B) a glycoside, and C) a benzene sulfonate, wherein the weight ratio of the component B and the component C is less than or equal to 5:1.

According to the invention, the cleaning composition has a high cloud point, a low foam level, a high cleaning efficacy, lower corrosion, and high oil removing ability or the like, and is compatible with an enzyme cleaner, which can be used as a detergent for cleaning medical appliances.

### DETAILED DESCRIPTION OF THE INVENTION

The present invention relates to a cleaning composition with a higher cloud point and a lower foam level for cleaning medical appliances. As mentions in above background of the invention, the jet washing has drawn great attentions as a new washing method. If a detergent composition produces too much foam, it will weaken the jet water pressure, resulting in an unsatisfactory washing effect, and the foams overflow a washing machine or a washing tub, causing troubles in the washing process. For performing jet washing, a method of adding an antifoaming agent was considered. However, a satisfactory result in view of the combination of a washing power and an antifoaming power cannot be obtained. Currently, a detergent including a block copolymer type nonionic surfactant is mainly used for jet washing (see, U.S. Pat. No. 6,530,383). The block copolymer type nonionic surfactant includes an ethylene oxide (EO), a propylene oxide (PO) or the like in molecules and has a weak foaming power. However, for this kind of surfactants, a low foaming nonionic surfactant generally has a low cloud point being 40° C. or lower. However, for the manual washing, the manual operation temperature is often higher than 40° C., and thus, a lower cloud point is a problem for the operator, which makes the medical appliances unseen under the dilution.

Thus, an object of the invention is to provide a cleaning composition with a high cloud point and a low foam level for cleaning medical appliances.

In the invention, unless indicated otherwise, the term “cloud point” refers to a temperature at which a solution comprising a cleaning composition becomes from transparent to cloud. The specific measurement method for the cloud point of a cleaning composition will be specifically demonstrated below.

In the invention, unless indicated otherwise, the term “foam level” refers to the ability of a cleaning composition to produce foams after being diluted and stirred, and specifically, it is denoted by the total volumes of the foams produced when a cleaning composition is diluted and stirred. The specific measurement method for the foam level of a cleaning composition will be specifically demonstrated below.

One aspect of the invention is to provide a cleaning composition comprising A) a fatty alcohol-alkylene oxide copolymer, B) a glycoside, and C) a benzene sulfonate, wherein the weight ratio of the component B and the component C is less than or equal to 5:1. The cleaning composition provided in this invention has a high cloud point and a low foam level for cleaning medical appliances.

In the application, the cleaning composition comprises a fatty alcohol-alkylene oxide copolymer.

According to some embodiments of the present invention, the fatty alcohol-alkylene oxide copolymer is represented by the following formula (I):

RO(EO)ₙ(PO)ₘ(BO)ₛH formula (I)

wherein R is an alkyl group having 6 to 30 carbon atoms; EO represents an ethylene oxide repeating unit; PO represents a propylene oxide repeating unit; BO represents a butylene oxide repeating unit; n is an integer of from 0 to 40; m is an integer of from 0 to 15; and s is an integer of from 0 to 15, provided that when m and s are 0, n is not 0; when n and s are 0, m is not 0; and m, n and s are not 0 at the same time.

According to some preferable embodiments of the present invention, in the above formula (I), R is an alkyl group having 6 to 30 carbon atoms; EO represents an ethylene oxide repeating unit; PO represents a propylene oxide repeating unit; BO represents a butylene oxide repeating unit; n is an integer of from 0 to 18; m is an integer of from 0 to 10; and s is an integer of from 0 to 10, provided that when m and s are 0, n is not 0; when n and s are 0, m is not 0; and m, n and s are not 0 at the same time.

There is no particular limitation on R in the above formula (I) as long as it is a common alkyl group in the field and has 6 to 30 carbon atoms. The specific examples of R in formula (I) is a n-hexyl group, a n-heptyl group, a n-octyl group, a n-nonyl group, n-decyl group, n-undecyl group, n-dodecyl group, n-tridecyl group, n-tetradecyl group, or the like. Specifically, the preferable specific examples of R in formula (I) is n-decyl group, n-dodecyl group, n-tetradecyl group, or the like.

The specific examples of the fatty alcohol-alkylene oxide copolymers to be used in the formula (I) in the invention is one or more selected from the group consisting of C₁₀H₂₁(EO)₆(PO)₄H, C₁₂H₂₅(EO)₆(PO)₄H, C₁₄H₂₉(EO)₉H, and C₁₂H₂₅(EO)₆(PO)₄(BO)₃H or the like. These fatty alcohol-alkylene oxide copolymers can be obtained according to the traditional synthesis methods or from the commercial sources. The commercially available fatty alcohol-alkylene oxide copolymers can be selected from the group consisting of: LFW 1064 with a chemical structure of C₁₀H₂₁(EO)₆(PO)₄H purchased from Honglai Company; Teric 168, Teric 128 from Huntsman; and Plurafac LF 221, Plurafac LF 500, Plurafac LF 131 from BASF.

In the invention, the fatty alcohol-alkylene oxide copolymer as demonstrated above comprises 0.1 to 20% by weight of the total weight of the cleaning composition. Preferably, the fatty alcohol-alkylene oxide copolymer comprises 0.5 to 10% by weight of the total weight of the cleaning composition. More preferably, the fatty alcohol-alkylene oxide copolymer comprises 1 to 8% by weight of the total weight of the cleaning composition. Additionally, most preferably, the fatty alcohol-alkylene oxide copolymer comprises 1 to 5% by weight of the total weight of the cleaning composition.

In the application, the cleaning composition further comprises a glycoside for increasing the cloud point and improving the foaming property of the cleaning composition.

According to some embodiments of the present invention, the glycoside is represented by the following formula (II):

ROZₓ formula (II)

wherein R is a monovalent organic group, such as an alkyl group, a hydroxyalkyl group, an alkenyl group, a hydroxyalkenyl group, an aryl group, an alkylaryl group, a hydroxyalkylaryl group, an arylalkyl group, an alkenylaryl group or an arylalkenyl group, each of which has 6 to 30 carbon atoms, and preferably, 8 to 18 carbon atoms; Z represents a moiety derived from a reducing saccharide having 5 or 6 carbon atoms; and x is an integer of from 1 to 10.

There is no particular limitation on R in the above formula (II) as long as it is a common group in the field selected from the group consisting of an alkyl group, a hydroxyalkyl group, an alkenyl group, a hydroxyalkenyl group, an aryl group, an alkylaryl group, a hydroxyalkylaryl group, an arylalkyl group, an alkenylaryl group and an arylalkenyl group in the field and has 6 to 30 carbon atoms. The specific examples of R in formula (II) are selected from a n-hexyl group, a n-decyl group, a n-undecyl group, a n-dodecyl group or the like.

According to some embodiments of the present invention, in the above formula (II), the reducing saccharide is selected from the group consisting of glucose, fructose, lactose, and maltose or the like.

According to some embodiments of the present invention, in the above formula (II), Z represents a moiety derived from glucose.

These glycosides can be obtained according to the traditional synthesis methods or from the commercial sources. The commercially available glycosides can be selected from the group consisting of: Glucopon 425N having a chemical structure of formula (II) wherein R is a n-decyl group, Z represents a moiety derived from glucose and x is 1, which is purchased from Dowcorning Company; Glucopon 425 N, Glucopon 425N/HH, Glucopon 650EC from Dowcorning; and Oramix NS 10 from Seppic.

In the invention, the glycoside as demonstrated above comprises 0.1 to 10% by weight of the total weight of the cleaning composition. Preferably, the glycoside comprises 0.1 to 8% by weight of the total weight of the cleaning composition. More preferably, the glycoside comprises 0.1 to 5% by weight of the total weight of the cleaning composition. Additionally, most preferably, the glycoside comprises 0.2 to 3% by weight of the total weight of the cleaning composition.

In the application, the cleaning composition further comprises a specific benzene sulfonate as a solubilizer. It should be noted that the addition of the benzene sulfonate can help to increase the cloud point and improve the foaming property of the cleaning composition, resulting in a synergistic effect of the glycoside and the benzene sulfonate on the clouding and foaming properties of the obtained cleaning composition.

According to some preferable embodiments of the present invention, the specific benzene sulfonate to be used in the invention is one or more selected from the group consisting of sodium xylene sulfonate, 2,4-dimethylbenzenesulfonic acid sodium, sodium benzenesulfonate, p-toluenesulfonic acid sodium salt hydrate, and sodium cumenesulfonate or the like. A commercially available benzene sulfonate can be selected from the group consisting of: SXS93, that is, a sodium xylene sulfonate, purchased from Datang Chemical; and SXS40 from Datang Chemical.

In the invention, the benzene sulfonate as demonstrated above comprises 0.5 to 30% by weight of the total weight of the cleaning composition. Preferably, the benzene sulfonate comprises 1 to 15% by weight of the total weight of the cleaning composition. More preferably, the benzene sulfonate comprises 1 to 10% by weight of the total weight of the cleaning composition. Additionally, most preferably, the benzene sulfonate comprises 3 to 10% by weight of the total weight of the cleaning composition.

In the invention, the cleaning composition comprising A) a fatty alcohol-alkylene oxide copolymer, B) a glycoside, and C) a benzene sulfonate, the weight ratio of the component B and the component C is less than or equal to 5:1, preferably 1:30-5:1, more preferably 1:15-1:3. In such range of weight ratio of the component B and the component C, the cloud point of the cleaning composition will be increased significantly (more than or equal to 40° C.), in addition, the foam level will be kept in a low level (lower than or equal to 750 mL).

In the invention, the cleaning composition comprising A) a fatty alcohol-alkylene oxide copolymer, B) a glycoside, and C) a benzene sulfonate, preferably the weight ratio of the component A and the components (B+C) is less than or equal to 1:1, preferably more than or equal to 1:16 and less than or equal to 5:6. Such range of weight ratio of the component A and the components (B+C) will further help to increase the cloud point of the cleaning composition and keep the foam level in a low level.

It is well-known for those skilled in the art that the detergents used in hospitals are commonly dissolved in water. Thus, according to some embodiments of the present invention, in addition to the above ingredients of a fatty alcohol-alkylene oxide copolymer, a glycoside and a benzene sulfonate, the cleaning composition of the invention further comprises water whose amount adjusts the total weight of the cleaning composition to 100 percentages by weight.

Furthermore, in addition to the above ingredients of a fatty alcohol-alkylene oxide copolymer, a glycoside and a benzene sulfonate, in order to further improve the cleaning performance, antirusting property, deforming performance, antimicrobial effect of the cleaning composition of the invention, this cleaning composition can further comprise a chelating agent, an antirusting agent, a defoamer, an antimicrobial agent or the like.

In the invention, the chelating agent comprises 0 to 10% by weight of the total weight of the cleaning composition; the antirusting agent comprises 0 to 10% by weight of the total weight of the cleaning composition; the defoamer comprises 0 to 5% by weight of the total weight of the cleaning composition; and the antimicrobial agent comprises 0 to 0.045% by weight of the total weight of the cleaning composition.

According to the invention, the cleaning composition as described above has a high cloud point, a low foam level, a high cleaning efficacy, lower corrosion, and high oil removing ability or the like, and is compatible with an enzyme cleaner, which can be used as a detergent for cleaning medical appliances.

The cleaning composition of the invention can be prepared according to the traditional preparation method well-known in the field. Specifically, the cleaning composition can be prepared by mixing the components as desired in one step simply or separately in a certain sequence.

### Testing Methods:

In the invention, the properties of the samples obtained in each example are characterized according to the following methods.

### 1. Test for Foam Level

1.25 g of a sample from a cleaning composition prepared in an example below was added into a forced stirrer (Philip HR 1724), and then, 498.75 g of water was added thereto. Subsequently, the forced stirrer was turned on for 20 s at a power of 300 W. The total volume of the produced foams and the liquid in the forced stirrer was recorded and regarded as the Foam Level (with a unit of mL) of the sample. It should be noted that a low foam level means that the foam level is lower than 750 mL.

### 2. Test for Cloud Point

The cleaning composition sample was heated with a heater gradually. At the same time, the appearance of the mixture was heated with a heater gradually. At the same time, the appearance of the mixture was observed with naked eyes, and the temperature at which the transparent mixture became clouding was recorded as the cloud point (with a unit of ° C.) of the cleaning composition. Furthermore, when the temperature of the mixture decreased, the appearance of the mixture was observed with naked eyes for confirming the temperature at which the transparent mixture became clouding once more. This test was repeated for three times for confirmation.

### 3. Test for Cleaning Efficacy

A sample from a cleaning composition prepared in an example below was used to remove a standard test soils of Browne STF (Albert Browne Ltd.) and TOSI (Test Object Surgical Instruments)(PEREG GmbH). Specifically, the different cleaning formulations were evaluated in Getinge 46 (purchased from Getinge Company Limited). Browne STF and TOSI were used as the standard test soils. The following cleaning conditions were used: dilution ratio: 1:400, initial temperature for dilution was 45° C., and main washing time was 5 minutes at a temperature of 60° C. Then, the standard test soils STF and TOSI were evaluated by naked eyes. The samples which could remove 95% or more of the soils were evaluated as “Good”. The samples which could not achieve the above criterion were rated as “Poor”.

### 4. Test for Corrosion

The corrosion property of every samples prepared in the invention was evaluated based on China technical standard for disinfection. Specifically, based on GB 1220-75, a stainless steel plate with a diameter 24.0 mm, a total area of about 9.8 cm² was prepared. The stainless steel plate was cleaned and removed of an oxide layer with a No. 120 abrasive paper (GB 2477). Subsequently, the stainless steel plate was weighed to obtain the weight (m) of the stainless steel plate before corrosion. Then, 2 g of a sample was diluted with 198 g of water and then the stainless steel plate was dipped thereto. After 72 hours, the stainless steel plate was rinsed, dried and weighed to obtain the weight (mₜ) of the stainless steel plate after corrosion. The above procedure was repeated for 3 times. For each example, R (corrosive rate) was calculated according to the following formula:

$$R = \frac{8.76 \times {10}^{7} \times ( m - {m}_{t} - {m}_{k} )}{S \times t \times d}$$

wherein

R: corrosive rate (mm/a)

S: the total surface area of the stainless steel plate (cm²)

m: the weight of the stainless steel plate before corrosion (g)

t: time (h)

d: the density of the stainless steel plate (kg/m³)

mₜ: the weight of the stainless steel plate after corrosion

mₖ: weight loss of the stainless steel plate

The corrosion evaluation of the cleaning composition of the invention was determined by the following standards:

R<0.0100 no corrosion

0.0100<R<0.100 slight corrosion

0.100<R<1.00 middle corrosion

R [symbol] 1.00 heavy corrosion

### 5. Test for Oil Removing Efficacy

The oil removing ability of each sample from a cleaning composition prepared in an example below was measured. Specifically, 2 g of a sample was diluted with 198 g of water, and then, a 1 cm×1 cm stainless which was polluted with a 100 uL pig oil (Yixiangyuan Ltd.) which was colored with a yellow dye (Yellow pigment 11-1003 DHG, Clariant Corporation china) was dipped thereto. The medical appliance were washed for 10 minutes at a temperature of 40° C. Then, the medical appliance was evaluated by naked eyes. The samples which could remove 80% or more of the pig oil were evaluated as “Good”. The samples which could not achieve the above criterion were rated as “Poor”.

6. Test for Compatibility with an Enzyme Cleaner

Because the enzyme cleaner is one of the most important detergents used in the field, the compatibility of a cleaning composition with an enzyme cleaner is an important factor for estimating the practicability of the cleaning composition. Thus, the compatibility of each sample from a cleaning composition prepared in an example below with an enzyme cleaner was measured according to the following procedure. 2 g of a sample was diluted with 198 g water, and then 10 g of a 3M enzyme cleaner was added thereto. After stirring at room temperature for 10 minutes, the appearance of the mixture was observed with naked eyes. The samples whose appearance kept clear and enzyme activity unchanged was defined as “Good”. The samples whose appearance became cloudy and enzyme activity reduced was defined as “Poor”.

### EXAMPLES

The present invention is further illustrated by the following examples which should not be construed to limit the scope of the present invention. All parts and percentages are by weight unless otherwise indicated.

The following raw materials were used for experiments in the examples of present invention.

TABLE 1

| Names of | | |
|---|---|---|
| Product | Chemical structures | Suppliers |
| LFW 1064 | a fatty alcohol-alkylene oxide copolymer | Honglai |
| | with a chemical structure of | Company |
| | C₁₀H₂₁(EO)₆(PO)₄H | |
| Teric 168 | a fatty alcohol-alkylene oxide according | Huntsman |
| | to formula (I) in the invention | |
| Glucopon | a glucoside according to formula | Dowcorning |
| 425N | (II) in the invention | |
| Glucopon | a glucoside according to formula | Dowcorning |
| 425N/HH | (II) in the invention | |
| SXS93 | Sodium Xylene Sulfonate | Datang |
| | | Chemical |
| Trilon M | a chelating agent: N-methylglycine | BASF |
| | diacetic acid trisodium salt | |
| Irgacor L | an antirusting agent: | SF |
| 190 plus | trihexanoic acid | |
| DK Q1-1247 | a defoamer: Silicone emulsion | Dowcorning |
| Kathon CG | an antimicrobial agent: | Huaxin |
| | 5-Chloro-2-methyl-4-isothiazolin-3-one | Daily |

The chemical reagents in addition to the reagents listed in Table 1 are all from the common commercial sources.

### Example 1

0.1 g of LFW 1064, 0.1 g of Glucopon 425N and 0.5 g of SXS93 were added into 99.3 g of distilled water, and stirred at room temperature for 20 minutes, to obtain a cleaning composition for cleaning medical appliances comprising 0.1% by weight of LFW 1064, 0.1% by weight of Glucopon 425N and 0.5% by weight of SXS93. The cleaning composition was then subjected to performance characterizations (Foam Level, Cloud Point, Cleaning Efficacy, me Cleaner) according to the procedures and criterions as demonstrated in the above portion of Testing Methods. The results were shown in Table 2.

It was clear from the results in Table 2 that: when the weight ratio of the component B and the component C is 1:5, and the weight ratio of the component A and the components (B+C) is 1:6, the cleaning compositions obtained in examples 1 could achieve good performances in Foam Level and Cloud Point.

### Examples 2-8

Examples 2-8 were performed according the same procedure as that in example 1 with an exception that the amounts of LFW 1064, Glucopon 425N and SXS93 were changed according to the data as shown in Table 2.

It was clear from the results in Table 2 that: when the weight ratio of the component B and the component C is less than or equal to 5:1, preferably 1:30-5:1, more preferably 1:15-1:3, the cleaning compositions obtained in examples 2-8 could achieve good performances in Cloud Point and Foam Level. In addition, if the weight ratio of the component A and the components (B+C) is less than or equal to 1:1, preferably more than or equal to 1:62 and less than or equal to 25:6, it will be more helpful to increase the cloud point of the cleaning composition and keep the foam level in a low level.

### Examples 9-17

Examples 9-17 were performed according the same procedure as that in example 1 with an exception that: the kinds of the surfactant were changed (that is, from LFW 1064 to Teric 168), and additionally, the amounts thereof were changed accordingly, as indicated in Table 2.

It was clear from the results in Table 2 that: when the weight ratio of the component B and the component C is less than or equal to 5:1, preferably 1:30-5:1, more preferably 1:15-1:5, the cleaning compositions obtained in examples 9-17 could achieve good performances in Cloud Point and Foam Level. In addition, if the weight ratio of the component A and the components (B+C) is less than or equal to 1:1, preferably more than or equal to 1:16 and less than or equal to 5:3, it will be more helpful to increase the cloud point of the cleaning composition and keep the foam level in a low level.

### Examples 18-21

Examples 18-21 were performed according the same procedure as that in example 1 with an exception that: the kinds of glucoside were changed (that is, from Glucopon 425N to Glucopon 425N/HH) and additionally, the amounts thereof were changed accordingly, as shown in Table 2.

It was clear from the results in Table 2 that: when the weight ratio of the component B and the component C is less than or equal to 5:1, preferably 1:3-1:5, the cleaning compositions obtained in examples 18-21 could achieve good performances in Cloud Point and Foam Level. In addition, if the weight ratio of the component A and the components (B+C) is less than or equal to 1:1, preferably 1:40-5:3, it will be more helpful to increase the cloud point of the cleaning composition and keep the foam level in a low level.

### Examples 22-25

Examples 22-25 were performed according the same procedure as that in example 1 with an exception that the amounts of LFW 1064, Glucopon 425N and SXS93 were changed according to the data as shown in Table 2. And furthermore, a chelating agent (Trilon M), an antirusting agent (Irgacor L 190 plus), a defoamer (DK Q1-1247) or an antimicrobial agent (Kathon CG) were added according to the data as shown in Table 2, respectively.

It was clear from the results in Table 2 that: when the weight ratio of the component B and the component C is less than or equal to 5:1, preferably 1:12-1:8, the cleaning compositions obtained in examples 22-25 could achieve good performances in Cloud Point and Foam Level. In addition, if the weight ratio of the component A and the components (B+C) is less than or equal to 1:1, preferably more than or equal to 1:13 and less than or equal to 2:9, it will be more helpful to increase the cloud point of the cleaning composition and keep the foam level in a low level.

### Comparative Examples 1 and 2

Comparative Examples 1 and 2 were performed according the same procedure as that in example 1 respectively with an exception that: in comparative example 1, the addition of Solubilizer (SXS93) was omitted; and in comparative example 2, the addition of glucoside (Glucopon 425N) was omitted.

It was clear from the results as shown in Table 2 that the products produced in comparative examples 1 had high foam level and low cloud point.

### Comparative Examples 3-7

Comparative Examples 3-7 were performed according the same procedure as that in example 1 with an exception that the amounts of LFW 1064, Glucopon 425N and SXS93 were changed according to the data as shown in Table 2.

It was clear from the results in Table 2 that: when the weight ratio of the component B and the component C is more than 5:1, the cleaning compositions obtained in comparative examples 3-7 have low performances in Cloud Point (lower than 40° C.) and Foam Level (higher than 750 mL).

TABLE 2

| | | | | | | | | | | | | | | Oil | Compat- |
|---|---|---|---|---|---|---|---|---|---|---|---|---|---|---|---|
| | | | | | | | | | Anti- | | | Clean- | | Remov- | ibility |
| Exam- | | | | | Ratio | Che- | Anti- | | micro- | Foam | Cloud | ing | | ing | with |
| ple | Surfac- | Gluco- | Solubi- | Ratio of | of A and | lating | rusting | De- | bial | Level | Point | Effi- | Corro- | Effi- | Enzyme |
| No. | tant (A) | side (B) | lizer (C) | B and C | (B + C) | agent | agent | foamer | agent | (mL) | (° C.) | cacy | sion | cacy | Cleaner |
| Ex-1 | LFW 1064 | Gluco- | SXS93 | 1:5 | 1:6 | — | — | — | — | 520 | 57-60 | — | no | — | good |
| | (0.1 wt %) | pon 425N | (0.5 wt %) | | | | | | | | | | | | |
| | | (0.1 wt %) | | | | | | | | | | | | | |
| Ex-2 | LFW 1064 | Gluco- | SXS93 | 1:5 | 1:1 | — | — | — | — | 600 | 42-45 | good | no | good | good |
| | (0.6 wt %) | pon 425N | (0.5 wt %) | | | | | | | | | | | | |
| | | (0.1 wt %) | | | | | | | | | | | | | |
| Ex-3 | LFW 1064 | Gluco- | SXS93 | 1:3 | 1:4 | — | — | — | — | 550 | 60-63 | — | no | — | good |
| | (0.1 wt %) | pon 425N | (0.3 wt %) | | | | | | | | | | | | |
| | | (0.1 wt %) | | | | | | | | | | | | | |
| Ex-4 | LFW 1064 | Gluco- | SXS93 | 1:30 | 1:62 | — | — | — | — | 520 | 75-78 | good | no | good | good |
| | (0.1 wt %) | pon 425N | (6 wt %) | | | | | | | | | | | | |
| | | (0.2 wt %) | | | | | | | | | | | | | |
| Ex-5 | LFW1064 | Gluco- | SXS93 | 1:15 | 1:16 | — | — | — | — | 550 | 57-60 | — | no | — | good |
| | (0.1 wt %) | pon 425N | (1.5 wt %) | | | | | | | | | | | | |
| | | (0.1 wt %) | | | | | | | | | | | | | |
| Ex-6 | LFW1064 | Gluco- | SXS93 | 1:5 | 25:6 | — | — | — | — | 580 | 43-46 | good | no | good | good |
| | (2.5 wt %) | pon 425N | (0.5 wt %) | | | | | | | | | | | | |
| | | (0.1 wt %) | | | | | | | | | | | | | |
| Ex-7 | LFW1064 | Gluco- | SXS93 | 1:30 | 25:31 | — | — | — | — | 600 | 43-46 | good | no | good | good |
| | (2.5 wt %) | pon 425N | (3.0 wt %) | | | | | | | | | | | | |
| | | (0.1 wt %) | | | | | | | | | | | | | |
| Ex-8 | LFW1064 | Gluco- | SXS93 | 5:1 | 1:6 | — | — | — | — | 780 | 37-40 | — | — | — | — |
| | (0.5 wt %) | pon 425N | (0.5 wt %) | | | | | | | | | | | | |
| | | (2.5 wt %) | | | | | | | | | | | | | |
| Ex-9 | Teric 168 | Gluco- | SXS93 | 1:5 | 1:6 | — | — | — | — | 520 | 57-60 | — | no | — | good |
| | (0.1 wt %) | pon 425N | (0.5 wt %) | | | | | | | | | | | | |
| | | (0.1 wt %) | | | | | | | | | | | | | |
| Ex-10 | Teric 168 | Gluco- | SXS93 | 1:5 | 5:3 | — | — | — | — | 600 | 45-48 | good | no | good | good |
| | (1.0 wt %) | pon 425N | (0.5 wt %) | | | | | | | | | | | | |
| | | (0.1 wt %) | | | | | | | | | | | | | |
| Ex-11 | Teric 168 | Gluco- | SXS93 | 1:5 | 1:15 | — | — | — | — | 620 | 52-55 | — | no | — | good |
| | (0.1 wt %) | pon 425N | (0.5 wt %) | | | | | | | | | | | | |
| | | (1.0 wt %) | | | | | | | | | | | | | |
| Ex-12 | Teric 168 | Gluco- | SXS93 | 1:15 | 1:16 | — | — | — | — | 550 | 57-60 | — | no | — | good |
| | (0.1 wt %) | pon 425N | (1.5 wt %) | | | | | | | | | | | | |
| | | (0.1 wt %) | | | | | | | | | | | | | |
| Ex-13 | Teric 168 | Gluco- | SXS93 | 1:15 | 5:16 | — | — | — | — | 580 | 53-56 | good | no | good | good |
| | (0.5 wt %) | pon 425N | (1.5 wt %) | | | | | | | | | | | | |
| | | (0.1 wt %) | | | | | | | | | | | | | |
| Ex-14 | Teric 168 | Gluco- | SXS93 | 1:30 | 5:31 | — | — | — | — | 590 | 53-56 | good | no | good | good |
| | (0.5 wt %) | pon 425N | (3.0 wt %) | | | | | | | | | | | | |
| | | (0.1 wt %) | | | | | | | | | | | | | |
| Ex-15 | Teric 168 | Gluco- | SXS93 | 1:11 | 5:6 | — | — | — | — | 600 | 46-49 | good | no | good | good |
| | (1.0 wt %) | pon 425N | (1.1 wt %) | | | | | | | | | | | | |
| | | (0.1 wt %) | | | | | | | | | | | | | |
| Ex-16 | Teric 168 | Gluco- | SXS93 | 5:1 | 6:15 | — | — | — | — | 660 | 49-52 | good | no | good | good |
| | (0.6 wt %) | pon 425N | (0.5 wt %) | | | | | | | | | | | | |
| | | 1.0 wt %) | | | | | | | | | | | | | |
| Ex-17 | Teric 168 | Gluco- | SXS93 | 5:1 | 1:12 | — | — | — | — | 650 | 45-48 | — | no | — | good |
| | (0.1 wt %) | pon 425N | (0.2 wt %) | | | | | | | | | | | | |
| | | (1.0 wt %) | | | | | | | | | | | | | |
| Ex-18 | LFW 1064 | Gluco- | SXS93 | 1:5 | 1:6 | — | — | — | — | 520 | 57-60 | — | no | — | good |
| | (0.1 wt %) | pon 425N/HH | (0.5 wt %) | | | | | | | | | | | | |
| | | (0.1 wt %) | | | | | | | | | | | | | |
| Ex-19 | LFW 1064 | Gluco- | SXS93 | 1:5 | 5:3 | — | — | — | — | 600 | 45-48 | good | no | good | good |
| | (1.0 wt %) | pon 425N/HH | (0.5 wt %) | | | | | | | | | | | | |
| | | (0.1 wt %) | | | | | | | | | | | | | |
| Ex-20 | LFW 1064 | Gluco- | SXS93 | 1:5 | 1:6 | — | — | — | — | 550 | 61-64 | — | no | good | good |
| | (0.1 wt %) | pon 425N/HH | (0.5 wt %) | | | | | | | | | | | | |
| | | (0.1 wt %) | | | | | | | | | | | | | |
| Ex-21 | LFW 1064 | Gluco- | SXS93 | 1:3 | 1:40 | — | — | — | — | 660 | 57-60 | good | no | good | good |
| | (0.1 wt %) | pon 425N/HH | (3 wt %) | | | | | | | | | | | | |
| | | (1 wt %) | | | | | | | | | | | | | |
| Ex-22 | LFW 1064 | Gluco- | SXS93 | 1:12 | 1:13 | Trilon M | Irgacor L | DK Q1-1247 | — | 580 | 55-58 | good | no | good | good |
| | (0.5 wt %) | pon 425N | (6 wt %) | | | (1 wt %) | 190 plus | (0.25 wt %) | | | | | | | |
| | | (0.5 wt %) | | | | | (1.5 wt %) | | | | | | | | |
| Ex-23 | LFW 1064 | Gluco- | SXS93 | 1:8 | 2:9 | Trilon M | Irgacor L | DK Q1-1247 | Kathon CG | 625 | 55-58 | good | no | good | good |
| | (1.0 wt %) | pon 425N | (4.0 wt %) | | | (1.5 wt %) | 190 plus | (0.5 wt %) | (1.5 wt %) | | | | | | |
| | | (0.5 wt %) | | | | | (1.0 wt %) | | | | | | | | |
| Ex-24 | LFW 1064 | Gluco- | SXS93 | 1:10 | 2:11 | — | — | DK Q1-1247 | Kathon CG | 650 | 60-63 | good | no | good | good |
| | (2.0 wt %) | pon 425N | (10.0 wt %) | | | | | (0.5 wt %) | (1.5 wt %) | | | | | | |
| | | (1.0 wt %) | | | | | | | | | | | | | |
| Ex-25 | LFW 1064 | Gluco- | SXS93 | 1:10 | 3:13 | — | — | — | Kathon CG | 700 | 58-61 | good | no | good | good |
| | (3 wt %) | pon 425N | (10.0 wt %) | | | | | | (1.5 wt %) | | | | | | |
| | | (1.0 wt %) | | | | | | | | | | | | | |
| CEx-1 | LFW 1064 | Gluco- | — | — | 1:1 | — | — | — | — | 520 | 21-24 | — | — | — | — |
| | (0.1 wt %) | pon 425N | | | | | | | | | | | | | |
| | | (0.1 wt %) | | | | | | | | | | | | | |
| CEx-2 | LFW 1064 | | SXS93 | — | 1:5 | — | — | — | — | 520 | 30-33 | — | — | — | — |
| | (0.1 wt %) | | (0.5 wt %) | | | | | | | | | | | | |
| CEx-3 | LFW 1064 | Gluco- | SXS93 | 6:1 | 1:7 | — | — | — | — | >1000 | 32-35 | — | — | — | — |
| | (2 wt %) | pon 425N | (2 wt %) | | | | | | | | | | | | |
| | | (12 wt %) | | | | | | | | | | | | | |
| CEx-4 | LFW1064 | Gluco- | SXS93 | 6:1 | 1:7 | — | — | — | — | 950 | 36-39 | — | — | — | — |
| | (0.5 wt %) | pon 425N | (0.5 wt %) | | | | | | | | | | | | |
| | | (3.0 wt %) | | | | | | | | | | | | | |
| CEx-5 | LFW1064 | Gluco- | SXS93 | 8:1 | 2:9 | — | — | — | — | >1000 | 36-39 | — | — | — | — |
| | (1.0 wt %) | pon 425N | (0.5 wt %) | | | | | | | | | | | | |
| | | (4.0 wt %) | | | | | | | | | | | | | |
| CEx-6 | LFW1064 | Gluco- | SXS93 | 25:1 | 2:11 | — | — | — | — | >1000 | 35-38 | — | — | — | — |
| | (1.0 wt %) | pon 425N | (0.5 wt %) | | | | | | | | | | | | |
| | | (5.0 wt %) | | | | | | | | | | | | | |
| CEx-7 | LFW1064 | Gluco- | SXS93 | 10:1 | 3:11 | — | — | — | — | >1000 | 30-33 | — | — | — | — |
| | (1.5 wt %) | pon 425N | (0.5 wt %) | | | | | | | | | | | | |
| | | (5.0 wt %) | | | | | | | | | | | | | |

In the above Table 2, “Ex” represents “example”; and “CEx” represents “comparative example”.

### INDUSTRIAL APPLICABILITY

The invention provides a cleaning composition having a high cloud point, a low foam level, a high cleaning efficacy, lower corrosion, and high oil removing ability or the like. This cleaning composition is compatible with an enzyme cleaner, can be prepared by a very simple mixing method and used as a detergent for cleaning medical appliances.

Although the invention is described with reference to the examples in detail, it is noted that the invention is not limited to the examples. The invention can be changed or modified without departing from the spirit of the invention.

1. A cleaning composition comprising
A) a fatty alcohol-alkylene oxide copolymer,
B) a glycoside, and
C) a benzene sulfonate,
wherein,
the weight ratio of the component B and the component C is less than or equal to 5:1.

2. The cleaning composition according to claim 1, wherein the fatty alcohol-alkylene oxide copolymer is represented by the following formula (I):
RO(EO)ₙ(PO)ₘ(BO)ₛH formula (I)
wherein R is an alkyl group having 6 to 30 carbon atoms; EO represents an ethylene oxide repeating unit; PO represents a propylene oxide repeating unit; BO represents a butylene oxide repeating unit; n is an integer of from 0 to 40; m is an integer of from 0 to 15; and s is an integer of from 0 to 15, provided that when m and s are 0, n is not 0; when n and s are 0, m is not 0; and m, n and s are not 0 at the same time.

3. The cleaning composition according to claim 2, wherein in formula (I), R is an alkyl group having 6 to 30 carbon atoms; EO represents an ethylene oxide repeating unit; PO represents a propylene oxide repeating unit; BO represents a butylene oxide repeating unit; n is an integer of from 0 to 18; m is an integer of from 0 to 10; and s is an integer of from 0 to 10, provided that when m and s are 0, n is not 0; when n and s are 0, m is not 0; and m, n and s are not 0 at the same time.

4. The cleaning composition according to claim 1, wherein the fatty alcohol-alkylene oxide copolymer is one or more selected from the group consisting of C₁₀H₂₁(EO)₆(PO)₄H, C₁₂H₂₅(EO)₆(PO)₄H, C₁₄H₂₉(EO)₉H, and C₁₂H₂₅(EO)₆(PO)₄(BO)₃H.

5. The cleaning composition according to claim 1, wherein the glycoside is represented by the following formula (II):
ROZₓ formula (II)
wherein R is an alkyl group, a hydroxyalkyl group, an alkenyl group, a hydroxyalkenyl group, an aryl group, an alkylaryl group, a hydroxyalkylaryl group, an arylalkyl group, an alkenylaryl group or an arylalkenyl group, each of which has 6 to 30 carbon atoms; Z represents a moiety derived from a reducing saccharide having 5 or 6 carbon atoms; and x is an integer of from 1 to 10.

6. The cleaning composition according to claim 5, wherein the reducing saccharide is glucose, fructose, lactose, or maltose.

7. The cleaning composition according to claim 5, wherein Z represents a moiety derived from glucose.

8. The cleaning composition according to claim 1, wherein the benzene sulfonate is one or more selected from the group consisting of sodium xylene sulfonate, 2,4-dimethylbenzenesulfonic acid sodium, sodium benzenesulfonate, p-toluenesulfonic acid sodium salt hydrate, and sodium cumenesulfonate.

9. The cleaning composition according to claim 1, wherein the weight ratio of B and C is 1:30-5:1.

10. The cleaning composition according to claim 1, wherein the weight ratio of B and C is 1:3-1:15.

11. The cleaning composition according to claim 1, wherein the weight ratio of the component A and the components (B+C) is less than or equal to 1:1.

12. The cleaning composition according to claim 11, wherein the weight ratio of the component A and the components (B+C) is more than or equal to 1:16, and less than or equal to 5:6.

13. The cleaning composition according to claim 1, wherein the fatty alcohol-alkylene oxide copolymer comprises 0.1 to 20% by weight of the total weight of the cleaning composition.

14. The cleaning composition according to claim 1, wherein the glycoside comprises 0.1 to 10% by weight of the total weight of the cleaning composition.

15. The cleaning composition according to claim 1, wherein the benzene sulfonate comprises 0.5 to 30% by weight of the total weight of the cleaning composition.

16. The cleaning composition according to claim 1, wherein the cleaning composition further comprises water.

17. The cleaning composition according to claim 1, wherein the cleaning composition further comprises one or more selected from the group consisting of a chelating agent, an antirusting agent, a defoamer and an antimicrobial agent.
